(19) United States
(12) Patent Application Publication
(10) Pub. No.: US 2026/0197863 A1
(43) Pub. Date: Jul. 9, 2026

(54) LOW LATENCY INDICATION IN WLANS

(71) Applicant: Samsung Electronics Co., Ltd., Suwon-si (KR)

(72) Inventors: Yue Qi, Plano, TX (US); Peshal Nayak, Plano, TX (US); Boon Loong Ng, Plano, TX (US); Vishnu Vardhan Ratnam, Frisco, TX (US); Rubayet Shafin, Frisco, TX (US); Bilal Sadiq, Plano, TX (US)

(21) Appl. No.: 19/441,742

(22) Filed: Jan. 6, 2026

Related U.S. Application Data
(60) Provisional application No. 63/743,506, filed on Jan. 9, 2025.
(60) Provisional application No. 63/756,381, filed on Feb. 10, 2025.
(60) Provisional application No. 63/770,113, filed on Mar. 11, 2025.
(60) Provisional application No. 63/852,564, filed on Jul. 28, 2025.

(51) Int. Cl. H04W 74/0808

(52) U.S. Cl. CPC H04W 74/0808

(57) ABSTRACT

Methods and systems for low latency indication in wireless local area networks (WLANs). A method performed by a transmission opportunity (TXOP) responder device includes receiving a frame from a TXOP initiator device. The method also includes generating a message including a low latency feedback information in response to the TXOP initiator device. The method further includes transmitting, to the TXOP initiator device, the message in a multi-station (multi-STA) block acknowledgement (BlockAck) frame. A method performed by a TXOP initiator device includes transmitting a frame to a TXOP responder device. The method also includes receiving a message including a low latency feedback information from the TXOP responder device. The message is in a multi-STA BlockAck frame.

### CROSS-REFERENCE TO RELATED APPLICATIONS AND CLAIM OF PRIORITY

The present application claims priority to U.S. Provisional Patent Application No. 63/743,506, filed on Jan. 9, 2025, U.S. Provisional Patent Application No. 63/756,381, filed on Feb. 10, 2025, U.S. Provisional Patent Application No. 63/770,113, filed on Mar. 11, 2025, and U.S. Provisional Patent Application No. 63/852,564, filed on Jul. 28, 2025. The contents of the above-identified patent documents are incorporated herein by reference.

### TECHNICAL FIELD

The present disclosure relates generally to wireless communication systems. More specifically, the present disclosure relates to a system and method for low latency indication in wireless local area networks (WLANs).

### BACKGROUND

Wireless local area network (WLAN) technology allows devices to access the internet in the 2.4 GHZ, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among users of mobile data devices, such as smart phones, tablets, “note pad” computers, net books, eBook readers, and machine type of devices. To address the issue of increasing bandwidth requirements demanded of wireless communications systems, different schemes are being developed to allow multiple user terminals to communicate with a single access point by sharing channel resources while achieving high data throughputs, such as by using Multiple Input Multiple Output (MIMO) technology.

### SUMMARY

The present disclosure relates generally to wireless communication systems and, more specifically, the present disclosure relates to a system and method for low latency indication in WLANs.

In one embodiment, a method performed by a transmission opportunity (TXOP) responder device is provided. The method includes receiving a frame from a TXOP initiator device. The method also includes generating a message including a low latency feedback information in response to the TXOP initiator device. The method further includes transmitting, to the TXOP initiator device, the message in a multi-station (multi-STA) block acknowledgement (BlockAck) frame.

In another embodiment, a method performed by a transmission opportunity (TXOP) initiator device is provided. The method includes transmitting a frame to a TXOP responder device. The method also includes receiving a message including a low latency feedback information from the TXOP responder device. The message is in a multi-station (multi-STA) block acknowledgement (BlockAck) frame.

In yet another embodiment, an electronic device is provided. The electronic device includes at least one processor including processing circuitry and a memory storing instructions. The instructions, when executed by the at least one processor individually or collectively, cause the electronic device to receive a frame from the TXOP initiator device and generate a message including a low latency feedback information in response to the TXOP initiator device. The instructions, when executed by the at least one processor individually or collectively, also cause the electronic device to transmit, to the TXOP initiator device, the message in a multi-station (multi-STA) block acknowledgement (BlockAck) frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example urgency grant subfield to prioritize low latency traffic according to embodiments of the present disclosure;

FIGS. 4A-4D illustrate example transmissions with low latency indications according to embodiments of the present disclosure;

FIGS. 5A-5B illustrate example multi-station block acknowledgement information with reserved traffic identifier (TID) values for low latency indication according to embodiments of the present disclosure;

FIG. 6 illustrates an example low latency parameter information field according to embodiments of the present disclosure;

FIGS. 7A-7B illustrate example low latency parameter information fields according to embodiments of the present disclosure;

FIG. 8 illustrates an example extended association identifier (AID) TID subfield format according to embodiments of the present disclosure;

FIG. 9 illustrates an example flow chart of a method for wireless communication performed by a transmission opportunity responder device according to embodiments of the present disclosure; and

FIG. 10 illustrates an example flow chart of a method for wireless communication performed by a transmission opportunity initiator device according to embodiments of the present disclosure.

### DETAILED DESCRIPTION

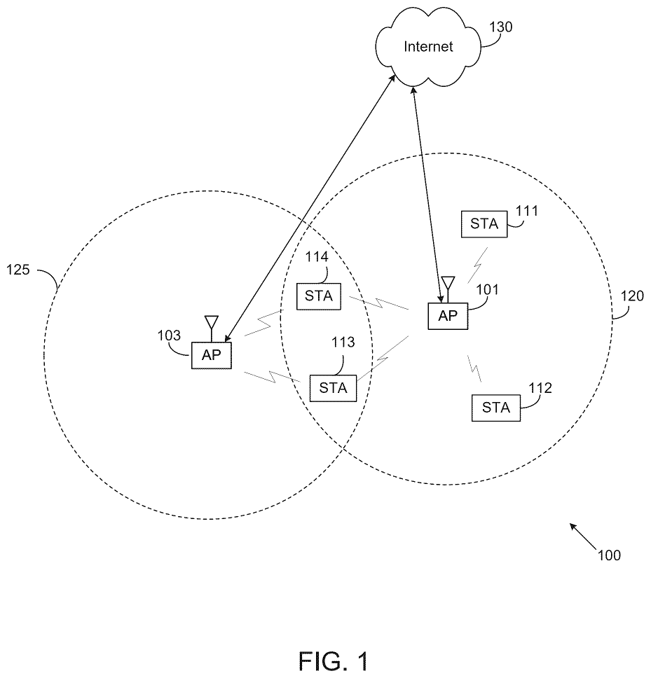

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, wireless local area network (WLAN) technology allows devices to access the internet in the 2.4 GHz, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

When a wireless device such as a non-AP device STA is associated with an access point, the device transmits measurement reports, sends data, and receives data through the associated access point. The device addresses frames, including channel state information measurement reports and compressed beamforming reports, to the associated access point, which is the sole intended recipient. The device configures its transmissions for proper reception at the associated access point and does not additionally configure those transmissions for reception at any unassociated access point.

Multiple access points, for example neighboring access points operating on at least one common channel, may coordinate to improve system performance in areas such as data rate, reliability, and latency. For example, two or more access points may coordinate beamforming or precoding decisions for simultaneous transmissions so that each access point can serve its associated STA while reducing interference to the STA served by the other access point at the same time. In another example, two or more access points may coordinate to achieve spatial reuse of the channel by transmitting them to their respective associated STA s that are partly shielded from the other access point because of current channel conditions, the environment, or relative locations.

However, these and other multi-access-point coordination schemes may require, or benefit from, obtaining a measurement report from a STA not only at the associated access point, as is customary, but also at one or more unassociated access points. More generally, a STA may transmit a frame addressed to its associated access point in which at least part of the information needs to be conveyed to at least one unassociated access point for the purpose of enabling multi-access-point coordination. The associated access point, after receiving the frame from the associated STA, may forward the relevant information to an unassociated access point using a backhaul link or a distribution system between access points. This approach may be inefficient, or infeasible if a backhaul link is unavailable.

Accordingly, the present disclosure provides systems and methods for configuring a transmission for reception at an associated STA and an unassociated STA. As described herein, the present disclosure includes systems and methods that may be performed by a non-AP device that includes STAs that each include a transceiver configured to form a link with an associated AP device and an unassociated AP device. The method may include generating, using the non-AP device, a message including a measurement report, and transmitting, to the associated AP device and the unassociated AP device, the message using a frame addressed to the associated AP device and configured for reception at the unassociated AP device.

The present disclosure, thus, provides an alternative that allows for the unassociated access point to obtain the relevant information by directly receiving and decoding, over the air, the STA's transmission to its associated access point. This disclosure provides techniques to enable that mode of operation. For example, the station can use these techniques to configure a measurement report addressed to its associated access point so that both the associated and unassociated access points can receive and correctly decode the transmission. In another example, the associated access point can use these techniques to provide a configuration to the STA, for example in a trigger frame, which the STA then uses for the transmission of a measurement report addressed to the associated access point, enabling both the associated and unassociated access points to receive and correctly decode the transmission. The associated access point and one or more unassociated access points that are part of a coordination group and attempt to receive and decode the STA's transmitted frames, including those containing measurement reports, may be referred to as coordinating access points.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating configuring a transmission for reception at an associated STA and an unassociated STA. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

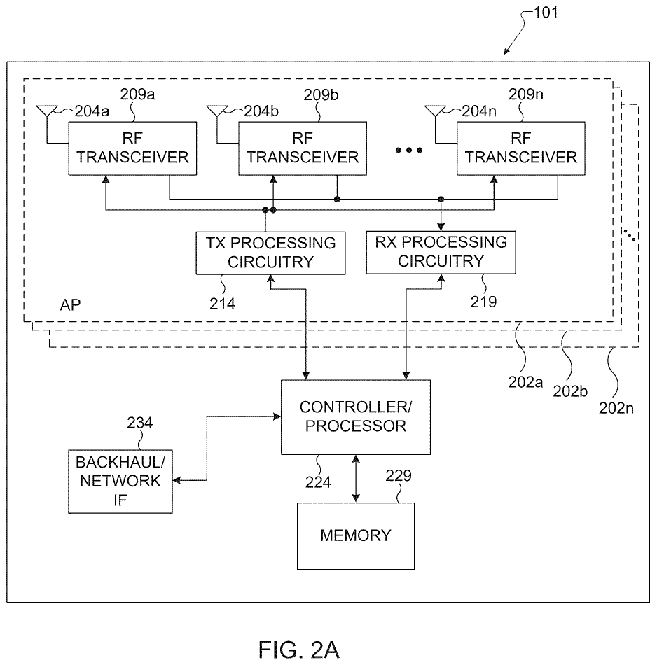

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHZ, or 6 GHZ, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating transmission for reception at an associated AP and an unassociated AP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for configuring a transmission for reception at an associated STA and an unassociated STA. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHZ, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a transmission for reception at an associated AP device and an unassociated AP device. In some embodiments, the controller/processor 240 includes at least one microprocessor or microcontroller.

The processor 240 is also capable of executing other processes and programs resident in the memory 260, such as operations for facilitating transmission for reception at an associated AP and an unassociated AP. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

In Wi-Fi standards, significant attention has been directed to reducing channel access delay for low-latency traffic required by real-time applications. The PAR for IEEE 802.11bn states an intent to define at least one mode of operation that improves the tail of the latency distribution and jitter compared to Extremely High Throughput MAC/PHY operation. Reducing latency to meet the growing demand for real-time applications is therefore a central objective in 802.11bn. The need for 802.11bn reflects more stringent performance requirements to support emerging applications, such as metaverse services, augmented and virtual reality, robotics, industrial automation for industrial IoT, logistics, and smart agriculture. Lower latency directly improves user experience, with particular emphasis on worst-case latency and jitter. Low-latency communication is a foundational requirement for real-time applications. Some use cases require latency below, for example, 5 milliseconds and jitter below 2 milliseconds.

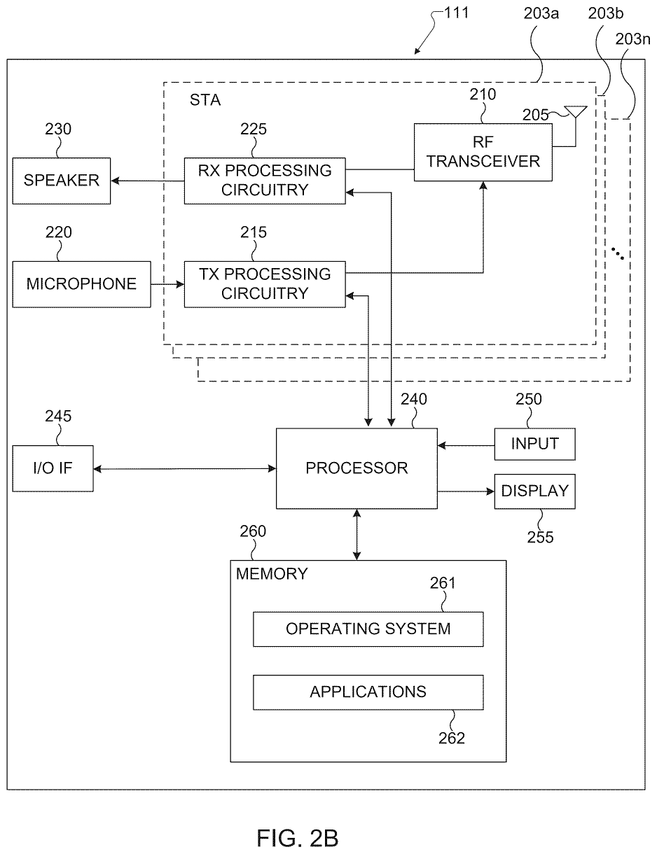

Current iterations of reverse direction (RD) grant or TXOP do not adequately support low-latency traffic. Once a TXOP has been obtained, there is no mechanism for users, including the RD or TXOP responder, to indicate the presence of ongoing low-latency traffic within that TXOP. Traffic that arises on the fly may need to contend only after the current TXOP concludes, which can lead to long channel access delays, particularly when the ongoing Physical Layer Protocol Data Unit (PPDU) or TXOP is lengthy. An explicit indication mechanism for low-latency traffic is therefore necessary. The specific information elements and signaling procedures for such an indication are discussed regarding FIGS. 3-10 below.

During RD grant or TXOP, frames include multi-STA BA, RTS, CTS, and similar control frames. In one embodiment, low latency information may be conveyed in a control request frame, such as a multi-STA BA frame. The information considered for low latency indication during an RD grant procedure may include AC types, traffic identifiers (TID), stream classification service (SCS) identification (ID), user priority, and urgency grant. The same categories of information may be considered for low latency indication within a TXOP.

With respect to AC type, the specification constrains a non-HE RD or TXOP responder to transmit Data frames only of the same AC as the last frame received from the RD or TXOP initiator. An HE RD or TXOP responder may transmit an Aggregate MAC Protocol Data Unit (A-MPDU) or a multi-TID A-MPDU that contains MPDUs from one or more ACs, provided that each such AC has a priority equal to or higher than the lowest priority AC of the MPDUs carried in the last PPDU received from the RD or TXOP initiator. Consequently, AC constraints are limited by the priority of the RD or TXOP initiator. In one embodiment, the RD or TXOP responder may indicate to the RD or TXOP initiator the AC type intended for the forthcoming low latency traffic. In another embodiment, the RD or TXOP initiator may adjust the AC priority to permit the RD or TXOP responder to transmit. For example, the RD or TXOP responder may indicate low latency traffic using an Access Category for Video (AC_VI) and Access Category Voice (AC_VO) in a frame, and the RD or TXOP initiator may then set the AC category and the priority of the last MPDU to AC_VI even if preceding MPDUs were transmitted using AC_VO. In another embodiment, the RD or TXOP initiator may refrain from changing the AC priority if the low latency indication is not successfully received or is rejected.

With respect to TID, if the AC Constraint subfield is equal to 0, the RD responder may transmit frames using any TID. In one embodiment, the RD or TXOP responder may support and include multiple TIDs with different ACs in its response to the TXOP holder, for example within an RD grant PPDU as an A-MPDU in a response burst or in TXS sharing. In another embodiment, a designated structure or field may carry information identifying TIDs, TID ranges, AC mapping for each MAC Service Data Unit (MSDU) in a TID list, and an AC mapping bitmap.

With respect to SCS ID, for a BAR or BA frame the AC is determined by examining the TID field. However, when multiple TIDs are added to the same AC within an SCS flow, this remapping may make AC examination more difficult. It may therefore be preferable to include the SCS ID in the low latency indication when an SCS has been set up during RD grant or low latency indication procedures. One to two bits may be allocated in the Per-AID TID Info Field to carry the SCS ID. The Per-AID TID Info Field is configured to indicate the presence of low latency needs and may include a low latency feedback field. The Per-AID TID Info field may be defined to include low latency information and may include one or more bits for the SCS ID of the low latency feedback information.

Additionally or alternatively, when multiple RD responders or TXOP responders are present within a single TXOP, a Low Latency Descriptor List for the SCS may be considered to include the low latency indication information for each user. Instead of a single information element, a descriptor list for each responder is defined within an initial control frame or control request frame, for example a multi-STA BA, a BA, or a CTS. This descriptor list enumerates each user, identifies the RD initiator and the RD responder, and sets out the low-latency parameters applicable to that user.

With respect to user priority, in one embodiment the indication information may include the UP. In another embodiment, if user priority (UP) and TIDs are remapped across different SCS flows, the indication field may include a set of values such as UP and TID together. The urgency grant may be included in additional fields as shown in FIG. 3.

FIG. 3 illustrates an example extended urgency grant subfield 300 according to embodiments of the present disclosure. For ease of explanation, the extended urgency grant subfield 300 will be described as including one or more components of the wireless network 100 of FIG. 1; however, the extended urgency grant subfield 300 could be implemented using any other suitable device or system. The embodiment of the extended urgency grant subfield 300 shown in FIG. 3 is for illustration only. Other embodiments of the extended urgency grant subfield 300 could be used without departing from the scope of this disclosure.

As shown in FIG. 3, the extended urgency grant subfield 300 includes an enqueue time field 302, an expiration time field 304, a remaining time field 306, and a delay bound field 308. One or more or any combination of the above fields may be considered in the low latency RD enhancement. The urgency grant information may be configured to prioritize low latency traffic and include enqueue time, expiration time, time-to-expiration, delay bounds, pending traffic duration, pending traffic queue size, or a combination thereof. The extended urgency grant subfield 300 allows for critical low latency traffic to be prioritized by carrying an urgency indication in the CRF or ICR, such as within a BA or M-BA frame. Urgency information may include enqueue time, expiration time, time to expiration, delay bounds, and pending traffic duration or queue size.

Although FIG. 3 illustrates an example of an extended urgency grant subfield 300, various changes may be made to FIG. 3. For example, various components of FIG. 3 could be combined, further subdivided, or omitted and additional components could be added according to particular needs.

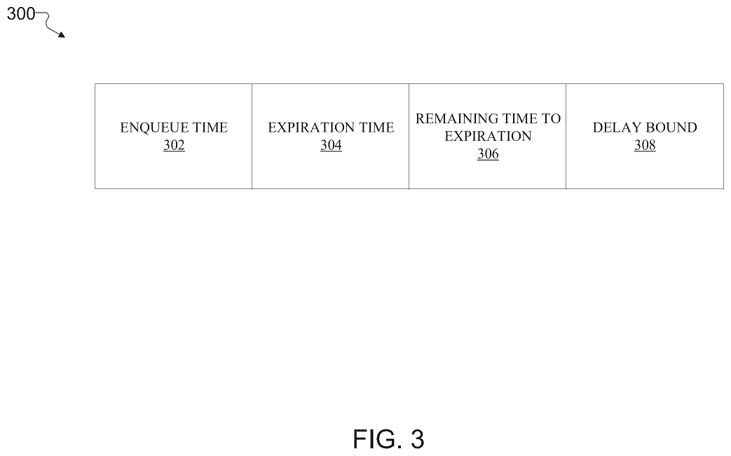

FIGS. 4A-4D illustrate example transmission flows 400A, 400B, 400C, 400D with low latency indications according to embodiments of the present disclosure. For ease of explanation, the transmission flows 400A, 400B, 400C, 400D will be described as including one or more components of the wireless network 100 of FIG. 1; however, the transmission flows 400A, 400B, 400C, 400D could be implemented using any other suitable device or system. The embodiments of the transmission flows 400A, 400B, 400C, 400D shown in FIGS. 4A-4D are for illustration only. Other embodiments of the transmission flows 400A, 400B, 400C, 400D could be used without departing from the scope of this disclosure.

As shown in FIG. 4A, the transmission flow 400A includes an RD grant transmission with LL indication. An RD initiator 402 transmits a BAR 410 to an RD responder 404. The RD responder 404 may include or otherwise be provided initial LL parameters 412. Upon receiving the BAR 410, the RD responder 404 transmits a multi-STA BlockAck frame 414 to the RD initiator 402. Additionally, the RD responder 404 may also transmit a RD LL PPDU 416 in accordance with a set schedule, such as concurrently or sequentially with the multi-STA BlockAck frame 414.

As shown in FIG. 4B, the transmission flow 400B includes a TXOP transmission with LL indication. A TXOP initiator 452 transmits a trigger frame 460 to a TXOP responder 454. As with the RD responder 404, the TXOP responder 454 may include or otherwise be provided initial LL parameters 412. Upon receiving the trigger frame 460, the TXOP responder 454 transmits a multi-STA BlockAck frame 414, an RD LL PPDU 416, or both (concurrently or sequentially) to the TXOP initiator 452.

As shown in FIGS. 4A-4B, the RD or TXOP initiator 402, 452 transmits a PPDU with an implicit BAR 410 and inquires about the low-latency needs of the RD or TXOP responder 404, 454 within that BAR 410. Additionally or alternatively, the RD or TXOP initiator 402, 452 transmits a control request frame and requests the low-latency needs of the RD or TXOP responder 404, 454 in that control request frame. The RD or TXOP initiator 402, 452 may carry its own low-latency information intended for the RD or TXOP responder 404, 454 in the current PPDU or in buffered MSDUs or AMSDUs. Additionally or alternatively, the RD or TXOP initiator 402, 452 carries a second STA's low-latency indication in a message to the first RD or TXOP responder 404, 454. For example, an RD initiator 402 may indicate a planned transmission by a second RD responder 404 to a first RD responder 404. This indication may include the start time, duration, medium time, and similar information so that the RD response burst remains within the request limit.

In another embodiment, the RD or TXOP responder 404, 454 carries a low-latency indication where the low-latency traffic is intended for delivery to a second STA other than the TXOP holder, such as other than the RD or TXOP initiator 402, 452. This indication may include the start time, duration, medium time, and similar information so that the RD response burst remains within the request limit.

In one embodiment, the RD or TXOP responder 404, 454 sends a low-latency indication through the multi-STA BlockAck frame 414 when the RD or TXOP initiator 402, 452 provides transmission opportunities. For example, the RD or TXOP responder 404, 454 sends a low-latency indication through the multi-STA BlockAck frame 414 and then sends an RD low-latency PPDU or a low-latency PPDU after SIFS following the multi-STA BlockAck frame 414 that carries the low-latency information. The RD or TXOP responder 404, 454 may carry initial low-latency parameters 412, such as a single bit of indication, with additional details, such as AC or TID constraints, SCS ID, and urgency, included in a subsequent RD low-latency PPDU. Additionally or alternatively, the RD or TXOP responder 404, 454 carries the low-latency parameters directly in the low-latency indication, such as AC or TID constraints, SCS ID, and urgency.

When the RD or TXOP initiator 402, 452 is an AP and the RD or TXOP responder 404, 454 is a non-AP STA, the RD or TXOP responder 404, 454 may send a multi-STA BlockAck frame 414 with the low-latency information. When the RD or TXOP initiator 402, 452 is an AP and the RD or TXOP responder 404, 454 is another AP, the RD transmission between APs may also carry additional information, such as BSS ID information, through the multi-STA BlockAck frame 414 or other initial control frames or trigger frames. When the RD or TXOP initiator 402, 452 is a non-AP STA and the RD or TXOP responder 404, 454 is an AP, the RD or TXOP responder 404, 454 may reply, using a STA, to any initial control frame with the low-latency information. When the RD or TXOP initiator 402, 452 is a non-AP STA and the RD or TXOP responder 404, 454 is another non-AP STA, the RD or TXOP responder 404, 454 may indicate the low-latency information through a tunneled direct link setup (TDLS) response frame, access network query protocol (ANQP) frames, or similar mechanisms.

In one embodiment, the TXOP holder may serve as the RD initiator 402, and the RD initiator 402 may serve as the TXOP holder. In another embodiment, the TXOP responder 454 may serve as the RD responder 404, and the RD responder 404 may serve as the TXOP responder 454.

The RD initiator 402 may transmit a frame either embedded in a PPDU or as a single frame to the RD responder 404. The RD responder 404 may transmit a multi-STA BlockAck frame 414 carrying low-latency parameters with detailed information, such as AC or TID constraints, SCS ID, urgency, and buffered status reports. After the multi-STA BlockAck frame 414, the RD responder 404 may transmit a low-latency PPDU with the preferred low-latency information.

As shown in FIG. 4C, the transmission flow 400C includes an RD grant transmission with LL indication where the LL parameters are indicated separately from other transmission details. For example, the transmission flow 400C may include a RD PPDU 420 transmitted from the RD initiator 402 to the RD responder 404. In response to receiving the RD PPDU 420, the RD responder 404 transmits the initial LL parameters 412 in the multi-STA BlockAck frame 414. The RD initiator 402 may then transmit a trigger frame 422 to the RD responder 404 that triggers the RD responder 404 to send the RD LL PPDU 416.

The RD or TXOP initiator 402, 452 transmits a control frame to request the LL information of the RD or TXOP responder 404, 454. The RD or TXOP responder 404, 454 then prepares the relevant initial LL parameters 412 and conveys initial LL information in the multi-STA BlockAck frame 414. Subsequently, the RD or TXOP initiator 402, 452 may transmit a trigger frame 422 or an initial control frame to obtain more detailed LL information, such as AC/TID constraints, SCS ID, urgency information, and buffered status reports. In response, the RD or TXOP responder 404, 454 may transmit an LL PPDU 416 that provides the detailed LL information, including AC/TID constraints, SCS ID, urgency information, and buffered status reports.

As shown in FIG. 4D, the transmission flow 400D includes a TXOP transmission with LL indication where the LL parameters are indicated separately from other transmission details and is configured similarly to the transmission flow 400C.

In one embodiment, the TXOP initiator 452 transmits either a frame embedded in a PPDU or a standalone PPDU to the TXOP responder 454. The TXOP initiator 452 may include an urgency indicator, for example low, medium, or high, so that the TXOP responder 454 may select appropriate low-latency parameters and PPDUs. The urgency level may be determined based on the head-of-line expiration time of the low-latency PPDUs. The TXOP responder 454 may transmit a multi-STA BlockAck frame 414 that carries the low-latency parameters with detailed information, such as AC/TID constraints, SCS identifier, and urgency information. After the multi-STA BlockAck frame 414, the TXOP responder 454 may transmit the low-latency PPDU with the preferred low-latency information.

Although FIGS. 4A-4D illustrate example transmission flows 400A, 400B, 400B, 400C, 400D with low latency indications, various changes may be made to FIGS. 4A-4D. For example, various components of FIGS. 4A-4D could be combined, further subdivided, or omitted and additional components could be added according to particular needs.

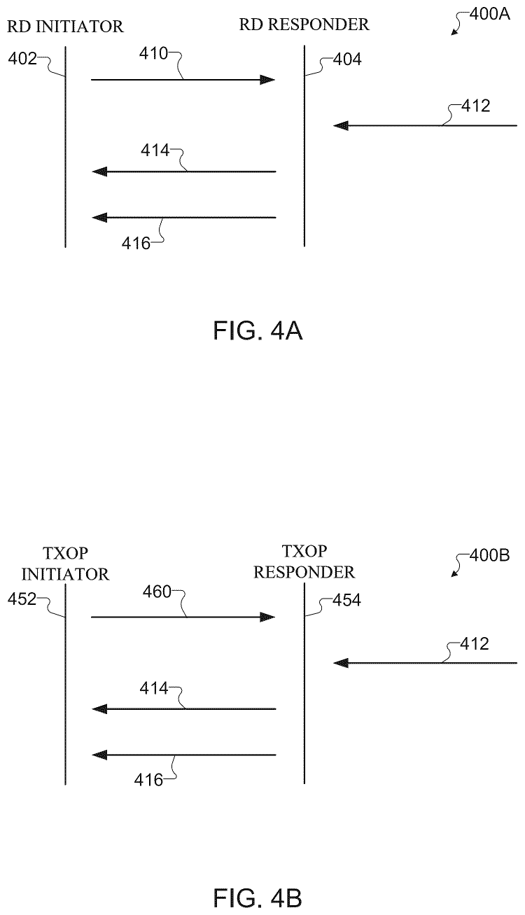

FIGS. 5A-5B illustrate example multi-STA BA information 500A, 500B with reserved traffic identifier (TID) values for low latency indication according to embodiments of the present disclosure. For ease of explanation, the multi-STA BA information 500A, 500B will be described as including one or more components of the wireless network 100 of FIG. 1; however, multi-STA BA information 500A, 500B could be implemented using any other suitable device or system. The embodiment of the multi-STA BA information 500A, 500B shown in FIGS. 5A-5B is for illustration only. Other embodiments of the multi-STA BA information 500A, 500B could be used without departing from the scope of this disclosure.

As shown in FIG. 5A, the multi-STA BA information 500A includes an AID TID info field 510 and an urgency info TID field 512. As shown in FIG. 5B, the multi-STA BA information 500B includes an AID11 subfield 550, an Ack Type field 552, a TID field 554, and an urgency info field 556.

According to certain embodiments, the multi-STA BA information, including an LL indication and LL information, may be included in the multi-STA BlockAck frame 414. The location of such information may be in one or more full fields or subfields of a block ACK (BA) Control Field, a BA Information field, a Per-association identifier (AID) traffic identifier (TID) Info field, an Aggregated control (A-Control) field, or a combination thereof. These fields are optional and may be interpreted by updated devices, and the overhead in frame transmission is maintained efficiently.

In one embodiment, low latency subfields may be included in the multi-STA BA Control field. Additionally or alternatively, an Extended BA Control field is used that includes an LL Indication bit and Priority subfields. Additionally or alternatively, a single-bit LL Presence Indication field is added to the BA Control field of the multi-STA BlockAck frame 414 to indicate the presence of low latency specific requirements and parameters. A reserved bit may be used for this purpose. If the bit is set to one, it instructs any receiving device that an extended block of LL parameters will follow. If the bit is set to zero, a regular RD response or non-LL traffic may follow. When the LL Indication bit is set, the receiver or RD initiator searches for additional LL details in the extension fields to enable quick detection of LL signaling.

In one embodiment, the Ack Type field 552 may include implicit or explicit acknowledgment. For example, the implicit ACK or BA or multi-STA BA may be embedded or aggregated in the RD LL MSDU.

In another embodiment, an LL Parameters Information Element or an extended subfield in the multi-STA BA may be used. The LL Parameters IE, or subfields in an existing extension field, may include the information described in Section I. In one embodiment, the Extended LL Parameters field has variable length and is present when the LL Indication bit is set to one. In another embodiment, the Extended LL Parameters field of variable length is present in the UHR multi-STA BlockAck frame 414, which is repurposed for LL indication.

In one embodiment, when the multi-STA BlockAck frame 414 frame from the RD responder is sent to an AP acting as the RD initiator, the AID11 subfield 550 must be set to zero. The Ack Type field 552 may be set to zero for Block Acknowledgement Context or to one for All Ack or Management Frame Ack. The reserved TID values from 8 through 13, as well as 14 and 15, may be used to indicate LL indication frames.

In another embodiment, when the multi-STA BlockAck frame 414 frame from the RD responder is sent to a non-AP STA acting as the RD initiator, the AID11 subfield 550 may be set to 1, the Ack Type field 552 may be set to either 0 or 1, and the reserved TID values from 8 through 13, 14, and 15 may be used to indicate LL indication frames. In a further embodiment, the Block Ack Starting Sequence Control subfield and the Block Ack Bitmap subfields may be omitted and the urgency information illustrated in FIG. 3 may be included instead. In one embodiment, a specific value, such as 2046, in the AID11 subfield 550 serves as an LL indicator for an associated STA. In another embodiment, a specific value, for example 2047, in the AID11 subfield 550 serves as an LL indicator for an unassociated STA. In an additional embodiment, a specific or reserved value in the TID subfield, for example any number from 8 to 15, serves as an LL indicator. In a further embodiment, a specific or reserved type in the Ack Type field 552 subfield, for example LL feedbacks, serves as an LL indicator. In another embodiment, a specific value in the Ack Type field 552 together with the BA type in the BA Control serves as an LL indicator for either an associated or an unassociated STA. Additionally or alternatively, a specific value in the AID11 subfield 550 combined with a particular Ack Type field 552 in the AID TID Info and a BA type in the BA Control indicates that an associated or unassociated STA is operating as an RD initiator with LL traffic.

Although FIGS. 5A-5B illustrate example multi-STA BA information 500A, 500B with reserved TID values for low latency indication, various changes may be made to FIGS. 5A-5B. For example, various components of FIGS. 5A-5B could be combined, further subdivided, or omitted and additional components could be added according to particular needs.

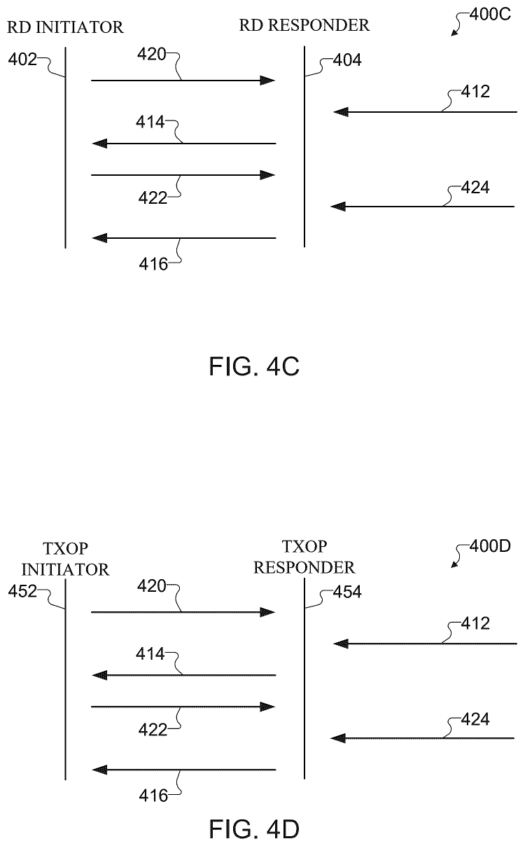

FIG. 6 illustrates an example LL parameter indication field 600 according to embodiments of the present disclosure. For ease of explanation, the LL parameter indication field 600 will be described as including one or more components of the wireless network 100 of FIG. 1; however, the LL parameter indication field 600 could be implemented using any other suitable device or system. The embodiment of the LL parameter indication field 600 shown in FIG. 6 is for illustration only. Other embodiments of the LL parameter indication field 600 could be used without departing from the scope of this disclosure.

As shown in FIG. 6, the LL parameter indication field 600 includes a Block Ack sequence control field 610 and a Block Ack bitmap 612. Additional subfields of the LL information may be positioned either before or after the existing Block Ack sequence control field 610 and Block Ack bitmap 612, or they may replace those subfields.

Additionally or alternatively, the urgency information may be embedded within the Block Ack bitmap 612. For example, a portion of the Block Ack bitmap 612 may be used to indicate urgency information, and specific bits within the bitmap could encode the urgency level for each frame being acknowledged.

Although FIG. 6 illustrates an example LL parameter indication field 600, various changes may be made to FIG. 6. For example, various components of FIG. 6 could be combined, further subdivided, or omitted and additional components could be added according to particular needs.

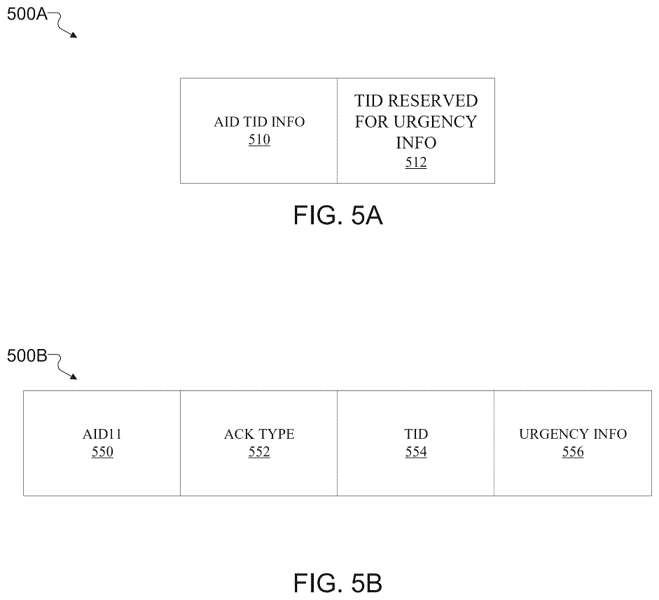

FIGS. 7A-7B illustrate example LL parameter indication fields 700A, 700B according to embodiments of the present disclosure. For ease of explanation, the LL parameter indication fields 700A, 700B will be described as including one or more components of the wireless network 100 of FIG. 1; however, the low LL indication fields 700A, 700B could be implemented using any other suitable device or system. The embodiment of the LL parameter indication fields 700A, 700B shown in FIGS. 7A-7B are for illustration only. Other embodiments of the LL parameter indication fields 700A, 700B could be used without departing from the scope of this disclosure.

As shown in FIG. 7A, the LL parameter indication field 700A is configured similarly to the multi-STA BA information 500A; however, the LL parameter indication field 700A also includes an LL feedback field 712.

A Specific Per AID TID Info field may be used to indicate low latency needs. The Block Ack Starting Sequence Control frame of FIG. 6 may be replaced with the urgency info field 710, which may carry the information described in the first section. The LL feedback field 712 may include low latency feedback or actions for the relevant needs and may replace the Block Ack bitmap field of FIG. 6. Additionally or alternatively, timing information may be included in the feedback field within the per AID TID field of the LL parameter indication field 700A.

As shown in FIG. 7B, the LL parameter indication field 700B is configured similarly to the extended urgency grant subfield 300; however, the LL parameter indication field 700B also includes a pending traffic duration field 754 and a reserved field 756.

Low latency feedback may include one or more indicators specified in a bitmap. For example, a value of zero may indicate no request, and a value of one may indicate a low latency traffic need or an uplink traffic request. Illustrative examples are shown in Table 1.

TABLE 1
LL feedbacks in RD responder or TXOP responder.

| Value or subfield | LL feedbacks |
|---|---|
| 0 | No action or needs |
| 1 | Low latency traffic needs or UL traffic request |
| 2 | UL or DL traffic request. |
| 3 | DL traffic request. |
| 4 | Request for TXOP sharing |
| 5 | P2P communication request |
| 6 | UL and P2P communication request. |
| 7 | Coexistence event notification. |
| 8 | Request for a role switch |
| 9 | Emergency transmission request. |
| 10 | Request for TXOP termination. |
| 11 | Link switch. From one link to another for urgent |
| | transmissions. |

Additionally, the low latency indication may be used to signal a switch from the current link to another link. Additionally or alternatively, bit values may encode the feedback, as illustrated in Tables 2 and 3.

TABLE 2
LL feedbacks in RD or TXOP responder.

| Value | LL feedbacks |
|---|---|
| 000 | No action or needs |
| 001 | Low latency traffic needs or UL traffic request. |
| 010 | UL and P2P communication request. |
| 011 | Reserved or for P2P communication request. |

TABLE 3
LL request for TXOP termination

| Value | LL feedbacks |
|---|---|
| 100 | Request for TXOP termination. |
| 101 | Coexistence event notification. |
| 110 | P2P communication request. |
| 111 | Can be done by terminating the TXOP using CF- |
| | end. Or start a link switch process. |

For example, a value of “1xx” indicates a request for TXOP termination, where the reason code begins with bit 1. For example, “101” denotes a coexistence event prompting TXOP termination, and a pure peer-to-peer mode, such as Wi-Fi Aware, which may be outside the scope of IEEE specifications, may be indicated using “110.” In another embodiment, the responder may act on the indication by terminating the TXOP using CF-End or by initiating a link switch process.

Although FIGS. 7A-7B illustrate example low latency parameter indication fields, various changes may be made to FIGS. 7A-7B. For example, various components of FIGS. 7A-7B could be combined, further subdivided, or omitted and additional components could be added according to particular needs.

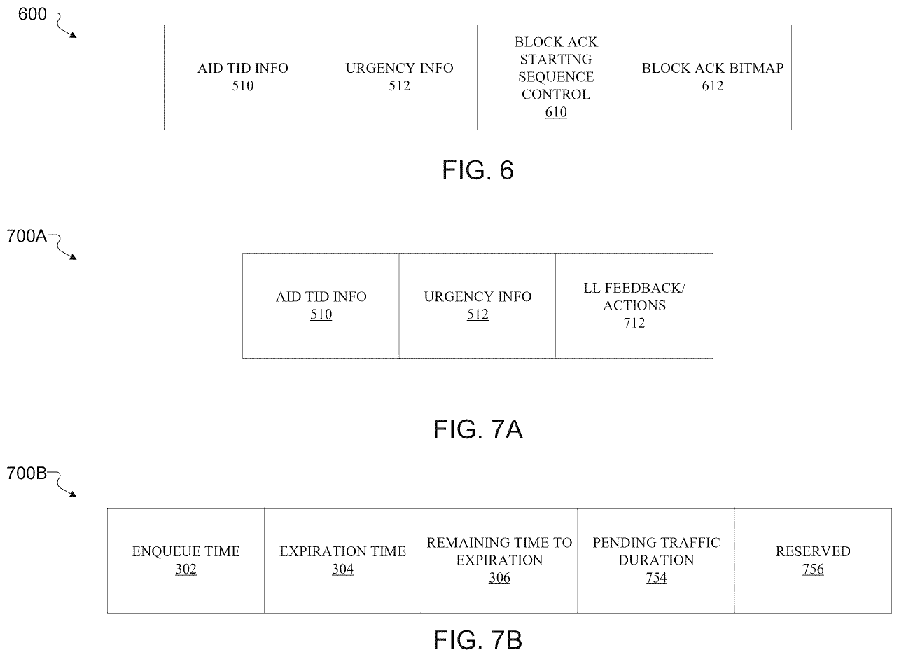

FIG. 8 illustrates an example association identifier (AID) TID subfield format 800 according to embodiments of the present disclosure. For ease of explanation, the AID TID subfield format 800 will be described as including one or more components of the wireless network 100 of FIG. 1; however, the AID TID subfield format 800 could be implemented using any other suitable device or system. The embodiment of the AID TID subfield format 800 shown in FIG. 8 is for illustration only. Other embodiments of the AID TID subfield format 800 could be used without departing from the scope of this disclosure.

As shown in FIG. 8, the extended AID TID info subfield format 800 includes a AID11 field 810, an Ack Type field 812, a TID field 814, an SCS ID field 816, and a user priority (UP) field 818.

The extended AID TID info subfield format 800 contains a set of identifiers, including the AID11 field 810, the Ack Type field 812, the TID field 814, the SCS ID field 816, and the UP field 818. Each field 810, 812, 814, 816, 818 may be associated with only one MSDU that appears in the subsequent low-latency RD PPDU, a PPDU burst, or buffered low-latency traffic. For example, the low latency feedback information may be configured to indicate buffered low latency traffic request or a peer-to-peer (P2P) traffic communication request to a second STA. To do so, the low latency indication feedback includes a bitmap value to indicate no request, a low latency traffic needs, or uplink (UL) traffic request. Each field 810, 812, 814, 816, 818 may also be associated with only one PPDU in the subsequent low-latency RD PPDU burst, a PPDU burst, or buffered low-latency traffic. In addition, each field 810, 812, 814, 816, 818 may identify the specific TID, UP, and AC applicable to the subsequent MSDUs, PPDU burst, or buffered low-latency traffic. It may further indicate the lowest priority among the relevant TID, UP, and AC for the subsequent MSDUs, PPDU, PPDU burst, or buffered low-latency traffic, as well as the highest priority among those same parameters for the subsequent MSDUs, PPDU, PPDU burst, or buffered low-latency traffic.

Although FIG. 8 illustrates an example AID TID subfield format 800, various changes may be made to FIG. 8. For example, various components of FIG. 8 could be combined, further subdivided, or omitted and additional components could be added according to particular needs.

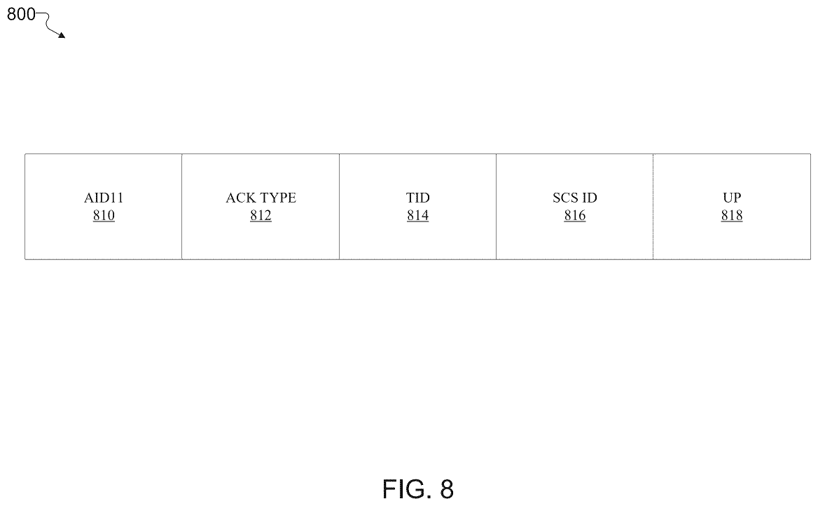

FIG. 9 illustrates an example method 900 for wireless communication performed by a TXOP responder device according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for wireless communication could be used without departing from the scope of this disclosure.

As shown in FIG. 9, a frame is received from a TXOP initiator device at step 902. For example, the RD or TXOP responder 404, 454 may receive a BAR 410 or an RD PPDU 420 from the RD or TXOP initiator 402, 452.

A message is generated including a low latency feedback information in response to the TXOP initiator device at step 904. For example, the RD or TXOP responder 404, 454 may generate a multi-STA BlockAck frame 414 in response to the BAR 410 or the RD PPDU 420. The multi-STA BlockAck frame 414 may include low latency indication information, such as the initial LL parameters 412 and additional parameters 424.

The message is transmitted to the TXOP initiator device in a multi-STA BlockAck frame at step 906. For example, the RD or TXOP responder 404, 454 may transmit the multi-STA BlockAck frame 414 to the RD or TXOP initiator 402, 452.

Although FIG. 9 illustrates one example method for wireless communication, various changes may be made to FIG. 9. For example, while shown as a series of steps, various steps in FIG. 9 could overlap, occur in parallel, occur in a different order, or occur any number of times. The steps 906 to 910 may be first followed by steps 902 to 904.

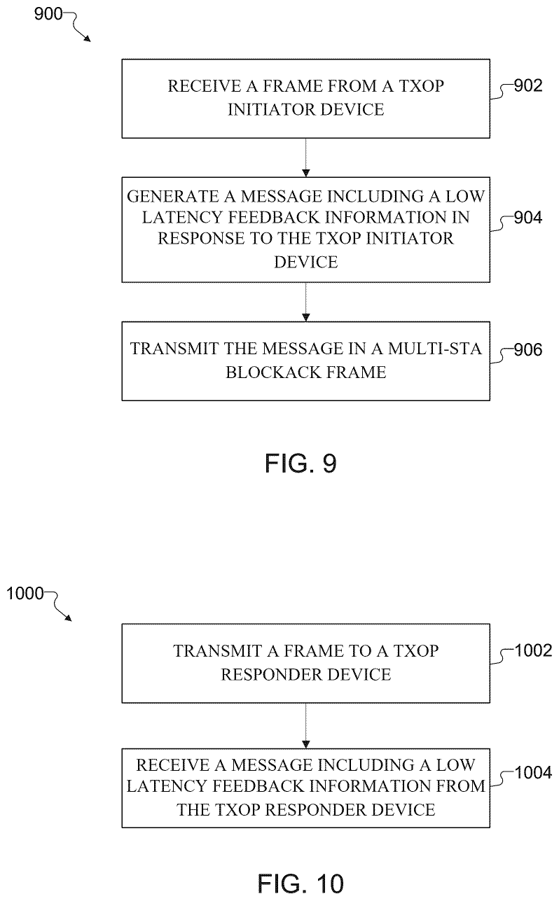

FIG. 10 illustrates an example method 1000 for wireless communication performed by a TXOP initiator device according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for wireless communication could be used without departing from the scope of this disclosure.

As shown in FIG. 10, a frame is transmitted to a TXOP responder device at step 1002. For example, the RD or TXOP initiator 402, 452 may transmit a BAR 410 or an RD PPDU 420 to the RD or TXOP responder 404, 454.

A message is received in response to the frame that includes a low latency feedback information from the TXOP responder device, where the message is in a multi-STA BlockAck frame at step 1004. For example, the RD or TXOP responder 404, 454 may transmit the multi-STA BlockAck frame 414 to the RD or TXOP initiator 402, 452. The multi-STA BlockAck frame 414 may contain the initial LL parameters 412 and additional parameters 424.

Although FIG. 10 illustrates one example method for wireless communication, various changes may be made to FIG. 10. For example, while shown as a series of steps, various steps in FIG. 10 could overlap, occur in parallel, occur in a different order, or occur any number of times. The steps 1006 to 1010 may be first followed by steps 1002 to 1004.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a transmission opportunity (TXOP) responder device, the method comprising:
receiving a frame from a TXOP initiator device;
generating a message including a low latency feedback information in response to the TXOP initiator device; and
transmitting, to the TXOP initiator device, the message in a multi-station (multi-STA) block acknowledgement (BlockAck) frame.

2. The method of claim 1, wherein the low latency feedback information includes at least one of a block ACK (BA) Control Field, a BA Information field, a Per-association identifier (AID) traffic identifier (TID) Info field, or an Aggregated control (A-Control) field.

3. The method of claim 2, wherein the multi-STA BlockAck frame includes the Per-AID TID Info field configured to indicate a presence of low latency needs, wherein the Per-AID TID Info field includes a low latency feedback field.

4. The method of claim 2, wherein the low latency feedback information is configured to indicate buffered low latency traffic request or a peer-to-peer (P2P) traffic communication request to a second STA.

5. The method of claim 2, wherein the low latency feedback information includes a bitmap value to indicate no request, a low latency traffic needs, or uplink (UL) traffic request.

6. The method of claim 1, wherein the low latency feedback information includes at least one of AC type, traffic identifiers (TID), stream classification service (SCS) identification (ID), user priority, and urgency grant information.

7. The method of claim 6, wherein the Per-AID TID Info field is defined to include low latency information, wherein the Per-AID TID Info field includes one or more bits for the SCS ID of the low latency feedback information.

8. The method of claim 6, wherein the urgency grant information is configured to prioritize low latency traffic and includes enqueue time, expiration time, time-to-expiration, delay bounds, pending traffic duration, pending traffic queue size, or a combination thereof.

9. A method performed by a transmission opportunity (TXOP) initiator device, the method comprising:
transmitting a frame to a TXOP responder device; and
receiving a message including a low latency feedback information from the TXOP responder device, wherein the message is in a multi-station (multi-STA) block acknowledgement (BlockAck) frame.

10. The method of claim 9, wherein the low latency feedback information includes at least one of a block ACK (BA) Control Field, a BA Information field, a Per-association identifier (AID) traffic identifier (TID) Info field, or an Aggregated control (A-Control) field.

11. The method of claim 10, wherein the multi-STA BlockAck frame includes the Per-AID TID Info field configured to indicate a presence of low latency needs, wherein the Per-AID TID Info field includes a low latency feedback field.

12. The method of claim 10, wherein the low latency feedback information is configured to indicate buffered low latency traffic request or a peer-to-peer (P2P) traffic communication request to a second STA.

13. The method of claim 10, wherein the low latency feedback information includes a bitmap value to indicate no request, a low latency traffic needs, or uplink (UL) traffic request.

14. The method of claim 9, wherein the low latency feedback information includes at least one of AC type, traffic identifiers (TID), stream classification service (SCS) identification (ID), user priority, and urgency grant information.

15. The method of claim 14, wherein the Per-AID TID Info field is defined to include low latency information, wherein the Per-AID TID Info field includes one or more bits for the SCS ID of the low latency feedback information.

16. The method of claim 14, wherein the urgency grant information is configured to prioritize low latency traffic and includes enqueue time, expiration time, time-to-expiration, delay bounds, pending traffic duration, pending traffic queue size, or a combination thereof.

17. An electronic device comprising:
at least one processor including processing circuitry; and
a memory storing instructions, wherein the instructions, when executed by the at least one processor individually or collectively, cause the electronic device to:
receive a frame from a transmission opportunity (TXOP) initiator device;
generate a message including a low latency feedback information in response to the TXOP initiator device; and
transmit, to the TXOP initiator device, the message in a multi-station (multi-STA) block acknowledgement (BlockAck) frame.

18. The electronic device of claim 17, wherein the low latency feedback information includes at least one of a block ACK (BA) Control Field, a BA Information field, a Per-association identifier (AID) traffic identifier (TID) Info field, or an Aggregated control (A-Control) field.

19. The electronic device of claim 18, wherein the multi-STA BlockAck frame includes the Per-AID TID Info field configured to indicate a presence of low latency needs, wherein the Per-AID TID Info field includes a low latency feedback field.

20. The electronic device of claim 18, wherein the low latency feedback information is configured to indicate buffered low latency traffic request or a peer-to-peer (P2P) traffic communication request to a second STA.
